(19) United States
(12) Patent Application Publication
(10) Pub. No.: US 2026/0318382 A1
(43) Pub. Date: Oct. 15, 2026

(54) SHOCK LOAD DAMPING UNIT

(71) Applicant: ITT Manufacturing Enterprises LLC, Wilimington, DE (US)

(72) Inventor: Shubin RUAN, Williamsville, NY (US)

(21) Appl. No.: 19/483,108

(22) PCT Filed: May 10, 2023
(86) PCT No.: PCT/US2023/021647

§ 371 Date: Nov. 10, 2025

(51) Int. Cl. F16F 9/48

(52) U.S. Cl. CPC F16F 9/486; F16F 2224/025; F16F 2224/046; F16F 2228/002

(57) ABSTRACT

A shock load damper includes a damper unit and a pneumatic spring. The damper unit includes a cylinder with a cylinder chamber and fluid. The damper unit includes a piston rod. The piston rod includes a first end with an impact load surface and a second end with a piston head assembly. The piston rod includes a piston rod chamber with fluid. The damper unit includes an orifice pin. The orifice pin includes an orifice pin chamber with fluid. An orifice is defined between an inner surface of the piston head assembly and an outer surface of the orifice pin. The pneumatic spring is coupled to and in fluid communication with the damper unit.

### CROSS REFERENCE TO RELATED APPLICATIONS

The present application is a National Stage and claims the benefit of and priority to International Application No. PCT/US2023/021647, filed on May 10, 2023, the entire contents of which are hereby incorporated by reference in their entirety.

### TECHNICAL FIELD

The present disclosure generally relates to a shock load damping unit for energy absorption and vibration isolation.

### BACKGROUND

Unless otherwise indicated herein, the materials described in this section are not prior art to the claims herein and are not admitted as being prior art by inclusion in this section.

Energy absorption and vibration isolation is important in the Manufacturing, Aerospace, Defense, Marine and Rail industries. Energy absorption and vibration isolation devices include shock absorbers, gas springs, rate controls, air springs, wire rope isolators, heavy industry buffers, and emergency stops. Shock absorbers are mechanical or hydraulic devices which absorb and dampen kinetic energy from a shock by converting and dissipating the energy. Most shock absorbers include a damper to resist motion through friction.

### SUMMARY

Existing challenges associated with the foregoing, as well as other challenges, are overcome by the presently disclosed shock load damper. One embodiment of the present disclosure is a shock load damper including a damper unit and a pneumatic spring. The damper unit includes a cylinder with a cylinder chamber and fluid. The damper unit includes a piston rod. The piston rod includes a first end with an impact load surface and a second end with a piston head assembly. The piston rod includes a piston rod chamber with fluid. The damper unit includes an orifice pin. The orifice pin includes an orifice pin chamber with fluid. An orifice is defined between an inner surface of the piston head assembly and an outer surface of the orifice pin. The pneumatic spring is coupled to and in fluid communication with the damper unit.

In aspects, the shock load damper unit is configured with the damper unit above or in parallel to the pneumatic spring.

In aspects, the orifice pin is a metering orifice pin.

In aspects, the orifice pin has a first diameter at a first end and a second diameter at a second end.

In aspects, the orifice decreases in cross-sectional area, or varies as a function of stroke to provide the required damping function when the piston rod is compressed into the cylinder chamber.

In aspects, the dampening unit is configured to provide a non-linear dampening force.

In aspects, the pneumatic spring includes a gas chamber with nitrogen.

In aspects, the pneumatic spring provides preload and a driving force to return the piston rod to a fully extended position when an impact load is removed.

In aspects, the shock load damper is configured to withstand a maximum load of about 35 kN applied in a compression direction on the impact load surface.

In aspects, the shock load damper further includes a fluid channel between the orifice pin chamber and a spring fluid chamber of the pneumatic spring.

In aspects, the shock load damper further includes hydraulic fluid within the cylinder chamber, piston rod chamber, orifice pin chamber, fluid channel, and the spring fluid chamber.

In aspects, the hydraulic fluid is a thermally stable silicone fluid.

In aspects, the piston rod and orifice pin provide a damping effect to a shock impact with a damping coefficient as a function of displacement and temperature of the hydraulic fluid.

Another embodiment of the present disclosure includes a method of dampening a shock impact force. The method includes receiving a shock impact force at an impact load surface of a piston rod of a damper unit. The method includes compressing the piston rod into a cylinder of the damper unit by the impact shock force. The compressing of the piston rod into the cylinder increases a pressure and temperature of a fluid within a cylinder chamber. The method includes passing at least some of the fluid with increased pressure and temperature through an orifice into a piston rod chamber and increasing a pressure and temperature of fluid within the piston rod chamber. The orifice is defined between an inner surface of a piston head assembly and an outer surface of an orifice pin. The method also includes moving at least some of the fluid within the piston rod chamber through holes in the piston rod into a secondary cylinder chamber and increasing a pressure and temperature of the fluid within the secondary cylinder chamber. The method also includes moving at least some of the fluid within the piston rod chamber into an orifice pin chamber within the orifice pin and increasing a pressure and temperature of the fluid within the orifice pin chamber. The method also includes moving at least some of the fluid within the orifice pin chamber into a fluid channel and increasing a pressure and temperature of the fluid within the fluid channel. The method also includes moving at least some of the fluid within the fluid channel into a fluid chamber of a pneumatic spring and increasing a pressure and temperature of the fluid within the fluid chamber of the pneumatic spring. The method also includes applying pressure to and moving a spring separator towards a gas chamber of the pneumatic spring to compress gas within the gas chamber of the pneumatic spring.

In aspects, the method further includes providing a driving force to return the piston rod to a fully extended position by the pneumatic spring when the impact load force is removed.

In aspects, the method further includes, prior to receiving the impact load force, providing a preload to the damper unit by the pneumatic spring.

Another embodiment of the present disclosure is a shock load damper including a damper unit and a pneumatic spring. The damper unit includes a cylinder with a cylinder chamber and fluid. The damper unit includes a piston rod. The piston rod includes a first end with an impact load surface and a second end with a piston head assembly. The piston rod includes a piston rod chamber with fluid. The damper unit includes a metering orifice pin with a first diameter at a first end and a second diameter at a second end. The metering orifice pin includes an orifice pin chamber with fluid. An orifice is defined between an inner surface of the piston head assembly and an outer surface of the orifice pin. The pneumatic spring includes a spring fluid chamber with fluid, a separator, and a gas chamber with nitrogen. The spring fluid chamber of the pneumatic spring is in fluid communication with the orifice pin chamber through a fluid channel.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a side perspective view of a shock load damper in accordance with the present disclosure;

FIG. 2 is a side cross sectional view of an expanded shock load damper in accordance with the present disclosure;

FIG. 3 is a side cross sectional view of a compressed shock load damper in accordance with the present disclosure;

FIG. 4 is a top cross sectional view of an expanded shock load damper in accordance with the present disclosure;

FIG. 5 is a front view of a shock load damper in accordance with the present disclosure;

FIG. 6 is a back view of a shock load damper in accordance with the present disclosure;

FIG. 7A is a back view of a lock wire routing for a shock load damper in accordance with the present disclosure;

FIG. 7B is a perspective back view of a lock wire routing for a shock load damper in accordance with the present disclosure;

FIG. 8A is a back view of a lock wire routing for a shock load damper in accordance with the present disclosure;

FIG. 8B is a perspective back view of a lock wire routing for a shock load damper in accordance with the present disclosure; and

FIG. 9 illustrates a flow diagram for an example method for dampening a shock impact force in accordance with the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

A shock load damper may include a cylinder, a piston assembly, a bearing assembly, a cylinder end, a metering pin, a hydraulic/gas separator, and a charge valve. The shock load damper may include an orifice system consisting of the metering orifice pin and an orifice ring and may be designed to permit controlled transfer of viscous fluid from one side of the piston to the other side of the piston. The orifice system may provide a damping coefficient as a function of displacement and temperature. An internal gas spring may provide a required preload and spring force as a function of displacement and temperature and may also provide piston rod volume compensation as well as a driving force to return the damper to a fully extended position when the load is removed. The hydraulic/gas separator may prevent the gas from mixing with the hydraulic fluid and provide consistent damping regardless of damper unit orientation.

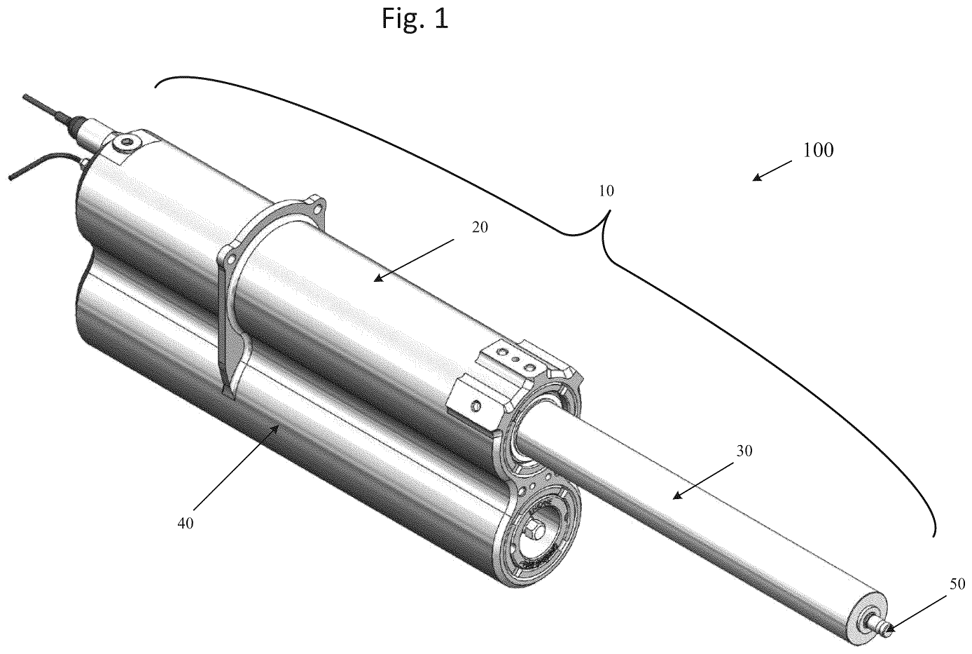

FIG. 1 is a side perspective view of a shock load damper, arranged in accordance with at least some embodiments described herein. A shock load damper 100 may include a damper unit 10 coupled to a pneumatic spring 40. Shock load damper 100 may be configured with damper unit 10 above or in parallel with pneumatic spring 40. Damper unit 10 may include a cylinder 20 and a piston rod 30. Piston rod 30 may be configured to extend out from cylinder 20 (as shown) as well as to be compressed into cylinder 20. An impact load interface 50 may be at the end of piston rod 30. As described in more detail below, damper unit 10 may be a viscous damper with a custom orifice and a progressive dampening coefficient for dissipating energy of a shock impact at impact load interface 50.

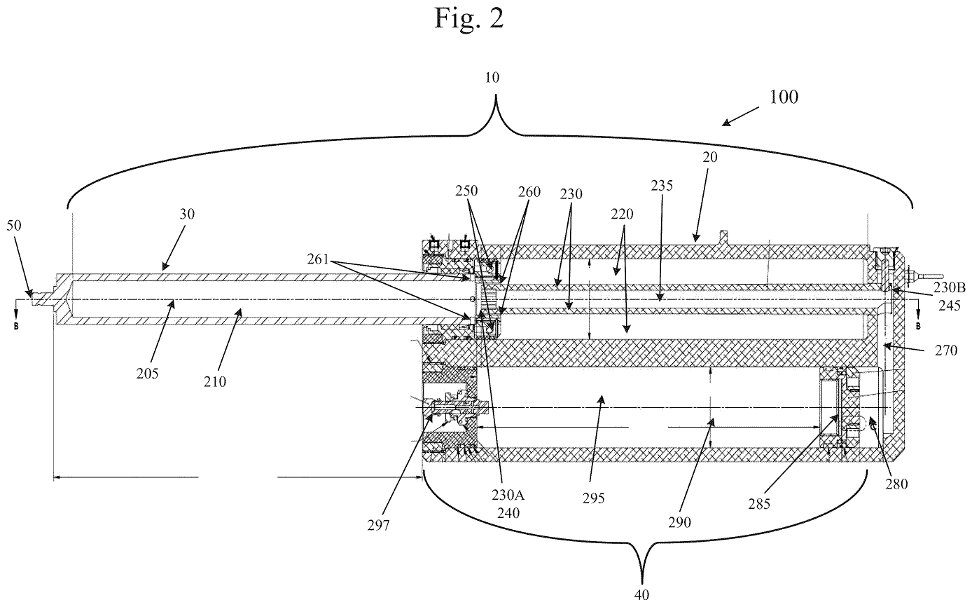

FIG. 2 is a side cross sectional view of an expanded shock load damper in accordance with at least some embodiments described herein. Those components in FIG. 2 that are labeled identically to components of FIG. 1 will not be described again for the purposes of brevity.

Piston rod 30 may include impact load interface 50 at a first end and a piston head assembly 250 including a wear ring, and an O-ring at a second end. Piston rod 30 may be hollow and define piston rod chamber 205. Piston rod chamber 205 may contain hydraulic fluid 210. Hydraulic fluid 210 may be a thermally stable silicone fluid such as Silicone 100 cSt (Dimethyl Polysiloxane) per Federal Specification VV-D-1078. Cylinder 20 may define a cylinder chamber 220. Piston head assembly 250 may seal piston rod 30 to an inner wall of cylinder chamber 220 when an impact force is applied to impact load interface 50 and piston rod 30 is compressed within cylinder 20. Cylinder chamber 220 may include an orifice pin 230 centrally located within cylinder chamber 220. Orifice pin 230 may be hollow and may define an orifice pin chamber 235 within orifice pin 230. Cylinder chamber 220 and orifice pin chamber 235 may include hydraulic fluid 210. Piston rod 30 and piston head assembly 250 along with orifice pin 230 may be configured to define a ring shaped orifice 260 between an inner surface of piston head assembly 250 and an outer surface of orifice pin 230. Piston rod 30 and piston head assembly 250 may be configured to overlay around and sheathe orifice pin 230 when piston rod 30 is compressed within cylinder 20. Orifice pin 230 and orifice 260 may define an orifice system configured to permit a controlled transfer of hydraulic fluid 210 from cylinder chamber 220 to the piston rod chamber 205. Cylinder chamber 220 may be in fluid communication with piston rod chamber 205 through orifice 260. Piston rod chamber 205 may also be in fluid communication with orifice pin chamber 235. Orifice pin chamber 235 may be in fluid communication with a hydraulic fluid chamber 280 of pneumatic spring 40 through a fluid channel 270.

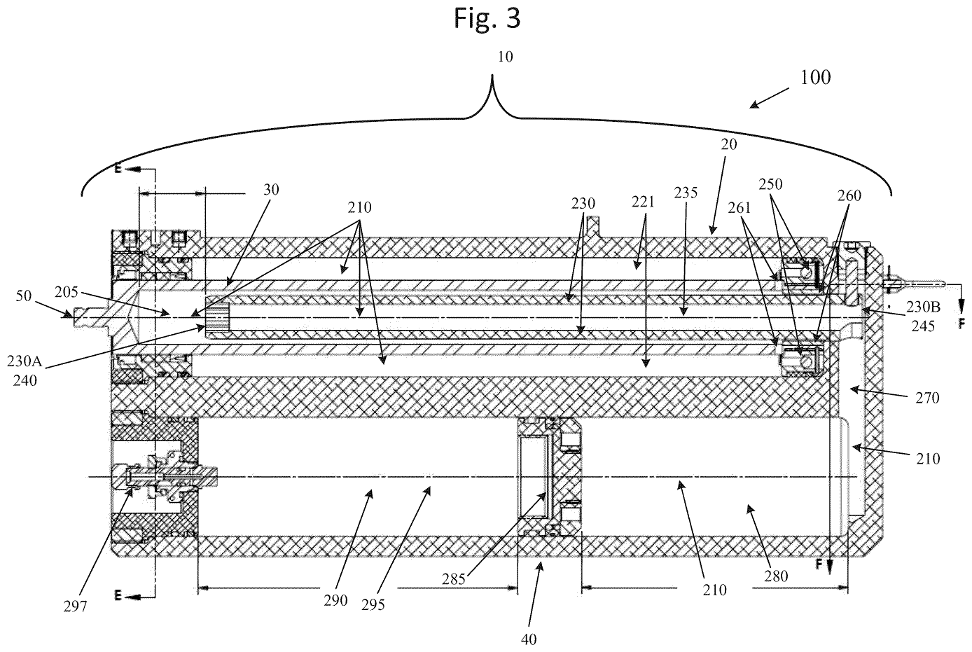

Hydraulic fluid 210 in cylinder chamber 220 may be compressed when piston rod 30 is compressed within cylinder chamber 220 and a pressure and temperature of hydraulic fluid 210 may increase. Hydraulic fluid 210 with increased pressure and temperature may pass through orifice 260 into piston rod chamber 205 causing hydraulic fluid 210 in piston rod chamber 205 to increase in pressure and temperature. Hydraulic fluid 210 increasing in pressure and temperature in piston rod chamber 205 may move into a secondary cylinder chamber 221 (shown in FIG. 3) formed between the outer surface of piston rod 30 and an inner wall of cylinder 20 as piston rod 30 is compressed into cylinder 20 of damper unit 10 and interact with and increase pressure and temperature of hydraulic fluid 210 in secondary cylinder chamber 221. Hydraulic fluid 210 increasing in pressure and temperature in piston rod chamber 205 may move into orifice pin chamber 235 and interact with and increase pressure and temperature of hydraulic fluid 210 in orifice pin chamber 235. Hydraulic fluid 210 increasing in pressure and temperature in orifice pin chamber 235 may move into channel 270 and interact with and increase pressure and temperature of hydraulic fluid 210 in channel 270. Hydraulic fluid 210 increasing in pressure and temperature in channel 270 may move into hydraulic fluid chamber 280 and interact with and increase pressure and temperature of hydraulic fluid 210 in hydraulic fluid chamber 280 of pneumatic spring 40. Hydraulic fluid 210 in hydraulic fluid chamber 280 of pneumatic spring 40 may apply pressure to and move spring separator 285 towards gas chamber 290 of pneumatic spring 40 to compress gas 295 within gas chamber 290. Gas 295 may be nitrogen (N) and pneumatic spring 40 may include a charge valve 297 for charging gas chamber 290 with gas 295. Shock load dampening unit 100 configured with damper unit 10 and pneumatic spring 40 may dampen a shock load impact with spring force from pneumatic spring 40 and non-linear dampening force from damper unit 10.

Orifice pin 230 may have a first end 230A proximate to the impact load interface 50 side of shock load damper 100 and a second end 230B proximate to a back side of shock load damper 100. Orifice pin 230 may be a metering orifice pin and may have a first diameter 240 at first end 230A and a second diameter 245 at second end 230B. Second diameter 245 may be larger than first diameter 240 and both diameters 240, 245 may be smaller than an interior diameter of hollow piston rod 30. Orifice 260 may have a smaller cross-section area as piston rod 30 travels along orifice pin 230 when piston rod 30 is compressed into cylinder chamber 220 resulting in higher pressure and temperature of hydraulic fluid 210 within cylinder chamber 220 as piston rod 30 is compressed into cylinder chamber 220. In another embodiment, a diameter of metering orifice pin 230 may vary as a function of stroke to produce a required damping function.

Piston rod 30 and orifice pin 230 may form an orifice system configured to control the transfer of viscous hydraulic fluid 210 from one side of the piston head assembly 250 to the other side of the piston head assembly 250 into cylinder chamber 220. Piston rod 30 and orifice pin 230 may provide a damping effect to shock impact with a damping coefficient as a function of displacement and temperature of hydraulic fluid 210. Pneumatic spring 40 may provide a preload and spring force to damper unit 10 as a function of displacement and temperature of hydraulic fluid 210 and temperature of gas 295. Pneumatic spring 40 may also provide piston rod 30 volume compensation and a driving force to return piston 30 to a fully extended position when an impact load is removed.

Piston rod 30 may have a stroke from an extended position to a compressed position of a minimum of about 250 mm. Shock load damper 100 may be configured with a minimum extended length of about 593.6 mm and a maximum extended length of about 596.6 mm. Shock load damper 100 may be configured to withstand a maximum impact velocity of 3.0 m/s (cable speeds of 6.0 m/s). Shock load damper 100 may be configured to withstand a maximum impact weight of 303 kg. Shock load damper 100 may be configured to withstand a complete load dump from a fully compressed position at any temperature condition and may have no permanent deformation and continue to function normally.

FIG. 3 is a side cross sectional view of a compressed shock load damper arranged in accordance with at least some embodiments described herein. Those components in FIG. 3 that are labeled identically to components of FIGS. 1-2 will not be described again for the purposes of brevity.

As shown in FIG. 3, when a shock impact force is applied to impact load interface 50, piston rod 30 may receive the shock impact force and be compressed within cylinder 20. When piston rod 30 is compressed within cylinder chamber 220, hydraulic fluid 210 in cylinder chamber 220 may be compressed and hydraulic fluid 210 may pass through orifice 260 into piston rod chamber 205, hydraulic fluid 210 in piston rod chamber 205 may be in fluid communication with secondary cylinder chamber 221 through flow holes 261 and may move into secondary cylinder chamber 221 thru holes 261, hydraulic fluid 210 in piston rod chamber 205 may also move into orifice pin chamber 235, hydraulic fluid 210 in orifice pin chamber 235 may move into channel 270, hydraulic fluid 210 in channel 270 may move into hydraulic fluid chamber 280 of pneumatic spring 40, and hydraulic fluid 210 in hydraulic fluid chamber 280 may apply pressure to and move spring separator 285 towards gas chamber 290 of pneumatic spring 40 to compress gas 295 within gas chamber 290. Shock load dampening unit 100 configured with damper unit 10 and pneumatic spring 40 may dampen a shock load impact with spring force from pneumatic spring 40 and non-linear dampening force from damper unit 10. When impact load is removed, pneumatic spring 40 may provide piston rod 30 volume compensation and a driving force to return piston 30 to a fully extended position.

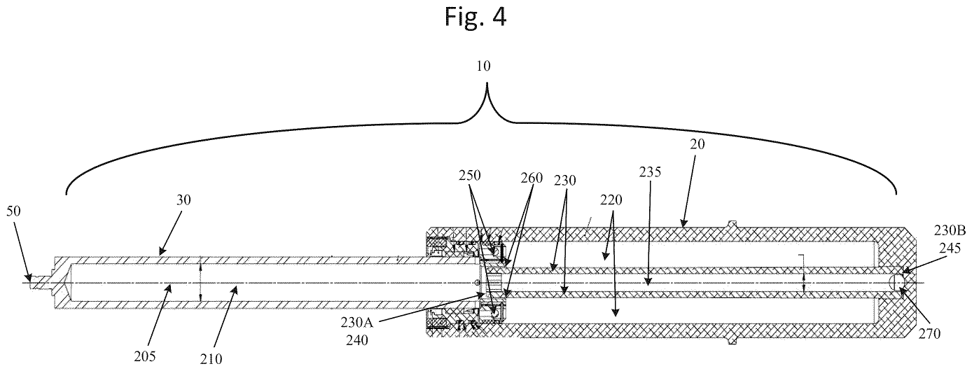

FIG. 4 is a top cross sectional view of an expanded shock load damper arranged in accordance with at least some embodiments described herein. Those components in FIG. 4 that are labeled identically to components of FIGS. 1-3 will not be described again for the purposes of brevity.

Damper unit 10 includes cylinder 20 and piston rod 30 configured to extend out from cylinder 20 (as shown) and to be compressed into cylinder 20 in response to force from an impact at impact load interface 50 of piston rod 30. Piston rod 30, piston head assembly 250 and orifice pin 230 define ring shaped orifice 260 between an inner surface of piston head assembly 250 and an outer surface of orifice pin 230. When a shock impact force is applied to impact load interface 50, piston rod 30 may be compressed into cylinder 20 and hydraulic fluid 210 in cylinder chamber 220 may be compressed and move through orifice 260 into piston rod chamber 205. Hydraulic fluid 210 in piston rod chamber 205 may move into secondary cylinder chamber 221 through holes 261. Hydraulic fluid 210 in piston rod chamber 205 may also move into orifice pin chamber 235 and hydraulic fluid 210 in orifice pin chamber 235 may move into channel 270. Hydraulic fluid 210 in channel 270 may interact with pneumatic spring 40 (Shown in FIGS. 1-3) and may apply pressure to compress gas of pneumatic spring 40. Damper unit 10 may dampen a shock load impact with a non-linear dampening force.

Shock load damper unit 10 may produce a damping force output within a specified output tolerance, in the compression (loading) direction, according to the following theoretical damping force relationship:

F_{damping}=C(x,T)*V

Where: F_{damping}=Damping Force output from the damper (N)
x=Stroke Position of damper (mm)
V=Relative Velocity of damper (m/s), and
C (x,T)=Damping Coefficient as a function of stroke and temperature (N/m·s)

Shock load damper unit 10 may be configured to withstand a maximum load of about 35 kN applied in the compression direction at any stroke position. Shock load damper unit 10 may be configured to have a nominal spring preload of about 8 kN. Shock load damper unit 10 may be configured to have a nominal spring endload of about 17.2 kN. Shock load damper unit 10 may be configured to be capable of sustaining an electro-static discharge between a helicopter and ground with a potential of 300 kV.

The following tables display results of simulations of shock load damper unit 10 for a damping coefficient as a function of stroke at 20° C., −45° C., and 55° C.

TABLE 1
Damping Coefficient as a Function of Stroke at 20 °C

| Stroke mm | N/(m/s) |
|---|---|
| 0 | 1485 |
| 5 | 1856 |
| 10 | 1856 |
| 15 | 1856 |
| 20 | 1856 |
| 25 | 1856 |
| 30 | 1856 |
| 35 | 1856 |
| 40 | 1856 |
| 45 | 1856 |
| 50 | 1856 |
| 55 | 1856 |
| 60 | 1856 |
| 65 | 1856 |
| 70 | 1856 |
| 75 | 1856 |
| 80 | 1856 |
| 85 | 1856 |
| 90 | 1856 |
| 95 | 1856 |
| 100 | 1856 |
| 105 | 1856 |
| 110 | 1856 |
| 115 | 1856 |
| 120 | 1866 |
| 125 | 1890 |
| 130 | 1932 |
| 135 | 1983 |
| 140 | 2044 |
| 145 | 2115 |
| 150 | 2201 |
| 155 | 2308 |
| 160 | 2447 |
| 165 | 2634 |
| 170 | 2894 |
| 175 | 3114 |
| 180 | 3334 |
| 185 | 3633 |
| 190 | 4339 |
| 195 | 4964 |
| 200 | 5390 |
| 205 | 5390 |
| 210 | 5390 |
| 215 | 5390 |
| 220 | 5390 |
| 225 | 5390 |
| 230 | 5390 |
| 235 | 5390 |
| 240 | 5390 |
| 245 | 5390 |
| 250 | 5390 |

TABLE 2
Damping Coefficient as a Function of Stroke at −45 °C

| Stroke mm | N/(m/s) |
|---|---|
| 0 | 3366 |
| 5 | 4207 |
| 10 | 4207 |
| 15 | 4207 |
| 20 | 4207 |
| 25 | 4207 |
| 30 | 4207 |
| 35 | 4207 |
| 40 | 4207 |
| 45 | 4207 |
| 50 | 4207 |
| 55 | 4207 |
| 60 | 4207 |
| 65 | 4207 |
| 70 | 4207 |
| 75 | 4207 |
| 80 | 4207 |
| 85 | 4207 |
| 90 | 4207 |
| 95 | 4207 |
| 100 | 4207 |
| 105 | 4207 |
| 110 | 4207 |
| 115 | 4207 |
| 120 | 4229 |
| 125 | 4284 |
| 130 | 4376 |
| 135 | 4491 |
| 140 | 4627 |
| 145 | 4785 |
| 150 | 4977 |
| 155 | 5214 |
| 160 | 5523 |
| 165 | 5936 |
| 170 | 6510 |
| 175 | 6993 |
| 180 | 7475 |
| 185 | 8087 |
| 190 | 9534 |
| 195 | 10801 |
| 200 | 11677 |
| 205 | 11677 |
| 210 | 11677 |
| 215 | 11677 |
| 220 | 11677 |
| 225 | 11677 |
| 230 | 11677 |
| 235 | 11677 |
| 240 | 11677 |
| 245 | 11677 |
| 250 | 11677 |

TABLE 3
Damping Coefficient as a Function of Stroke at 55 °C

| Stroke mm | N/(m/s) |
|---|---|
| 0 | 1192 |
| 5 | 1490 |
| 10 | 1490 |
| 15 | 1490 |
| 20 | 1490 |
| 25 | 1490 |
| 30 | 1490 |
| 35 | 1490 |
| 40 | 1490 |
| 45 | 1490 |
| 50 | 1490 |
| 55 | 1490 |
| 60 | 1490 |
| 65 | 1490 |
| 70 | 1490 |
| 75 | 1490 |
| 80 | 1490 |
| 85 | 1490 |
| 90 | 1490 |
| 95 | 1490 |
| 100 | 1490 |
| 105 | 1490 |
| 110 | 1490 |
| 115 | 1490 |
| 120 | 1498 |
| 125 | 1517 |
| 130 | 1549 |
| 135 | 1589 |
| 140 | 1637 |
| 145 | 1693 |
| 150 | 1760 |
| 155 | 1843 |
| 160 | 1952 |
| 165 | 2098 |
| 170 | 2300 |
| 175 | 2471 |
| 180 | 2641 |
| 185 | 2872 |
| 190 | 3418 |
| 195 | 3901 |
| 200 | 4231 |
| 205 | 4231 |
| 210 | 4231 |
| 215 | 4231 |
| 220 | 4231 |
| 225 | 4231 |
| 230 | 4231 |
| 235 | 4231 |
| 240 | 4231 |
| 245 | 4231 |
| 250 | 4231 |

As shown in Tables 1-3, shock load damper unit 10 may be configured with a soft start damping to eliminate a force spike at high speed impact. Tables 1-3 also illustrate that a damping coefficient of shock load damper unit 10 is dependent on temperature.

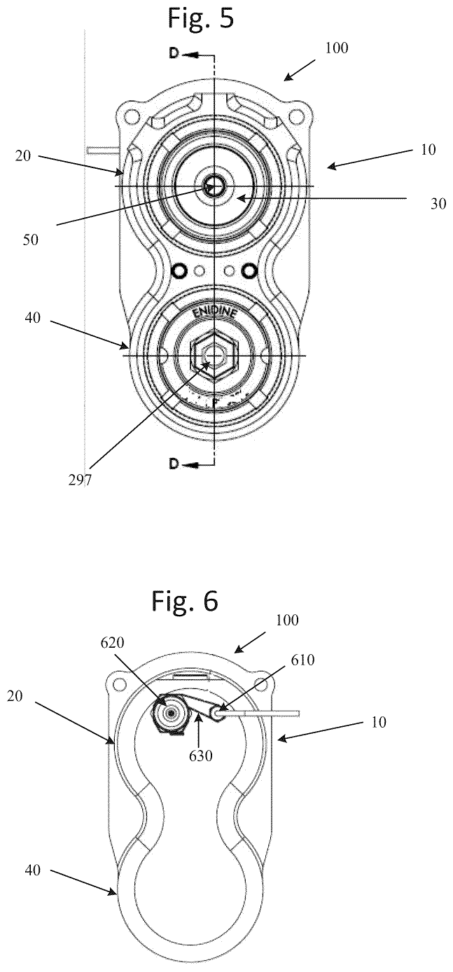

FIG. 5 is a front view of a shock load damper in accordance with the present disclosure, arranged in accordance with at least some embodiments described herein. Those components in FIG. 5 that are labeled identically to components of FIGS. 1-4 will not be described again for the purposes of brevity.

Front view of a shock load damper 100 illustrates damper unit 10 above pneumatic spring 40. Front view of damper unit 10 includes cylinder 20, piston rod 30, and impact load interface 50. Front view of pneumatic spring 40 includes charge valve 297.

FIG. 6 is a is a back view of a shock load damper in accordance with the present disclosure, arranged in accordance with at least some embodiments described herein. Those components in FIG. 6 that are labeled identically to components of FIGS. 1-5 will not be described again for the purposes of brevity.

The back view of a shock load damper 100 illustrates damper unit 10 above pneumatic spring 40. Damper unit 10 includes a temperature sensor 610, a pressure sensor 620, and lock wire 630.

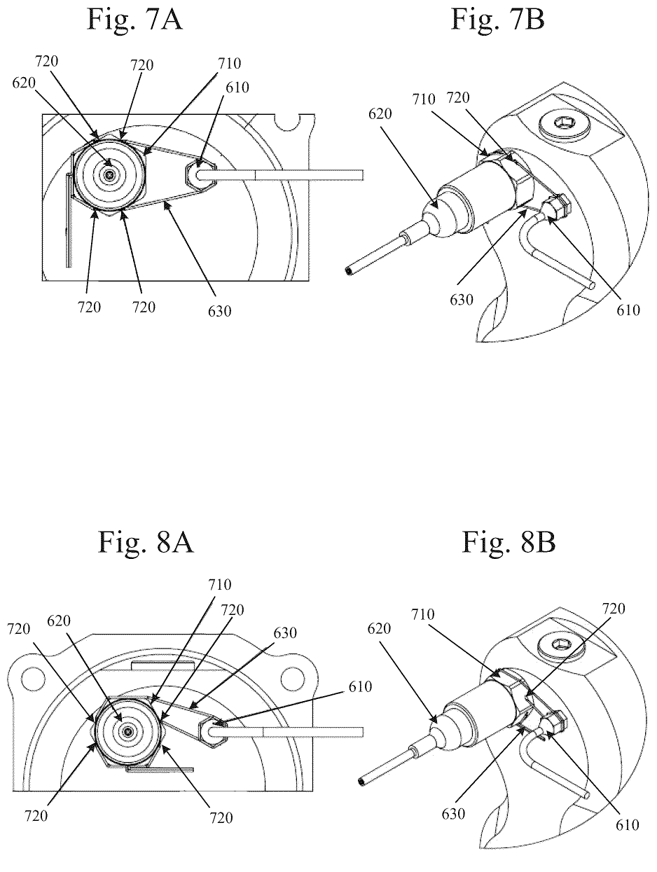

FIG. 7A is a back view of a lock wire routing for a shock load damper and FIG. 7B is a perspective back view of a lock wire routing for a shock load damper, both arranged in accordance with at least some embodiments described herein. Those components in FIGS. 7A and 7B that are labeled identically to components of FIGS. 1-6 will not be described again for the purposes of brevity.

The back view of a lock wire routing for a shock load damper shows temperature sensor 610, pressure sensor 620, lock wire 630, lock nut 710, and lock nut holes 720. As shown in FIGS. 7A and 7B, in a first embodiment, lock nut wire 630 may be threaded around multiple sides of securement nut of temperature sensor 610, through lock nut holes 720 at an upper side and a lower side of lock nut 710, and secured together at a back side of lock nut 710.

FIG. 8A is a back view of an alternate lock wire routing for a shock load damper and FIG. 8B is a perspective back view of an alternate lock wire routing for a shock load damper, both arranged in accordance with at least some embodiments described herein. Those components in FIGS. 8A and 8B that are labeled identically to components of FIGS. 1-7B will not be described again for the purposes of brevity.

The back view of a lock wire routing for a shock load damper shows temperature sensor 610, pressure sensor 620, lock wire 630, lock nut 710, and lock nut holes 720. As shown in FIGS. 8A and 8B, in a second embodiment, lock nut wire 630 may be threaded around multiple sides of securement nut of temperature sensor 610, through lock nut holes 720 at a front side and a back side of lock nut 710, and secured together at a bottom side of lock nut 710.

A device in accordance with the present disclosure may provide a shock load damper with non-linear spring function and non-linear damping function. A device in accordance with the present disclosure may provide a shock load damper with a custom orificed viscous damper with progressive damping coefficient coupled with a pneumatic spring which provides a specified preload and restoring force. A device in accordance with the present disclosure may provide a shock load damper which can maintain its set position when an impact load is less than a designed threshold and will absorb and dissipate input energy when an impact load exceeds a designed threshold. A device in accordance with the present disclosure may provide a shock load damper which can provide a required damping coefficient as a function of displacement and temperature. A device in accordance with the present disclosure may provide a shock load damper with a reduced length for applications that require a smaller shock load damper footprint. A device in accordance with the present disclosure may provide a shock load damper capable of providing shock load dampening for use with a Helicopter Flight Rescue System (HFRS) including an insertion and extraction tool that utilizes a longline and Personnel Carrying Device System (PCDS) rescue line.

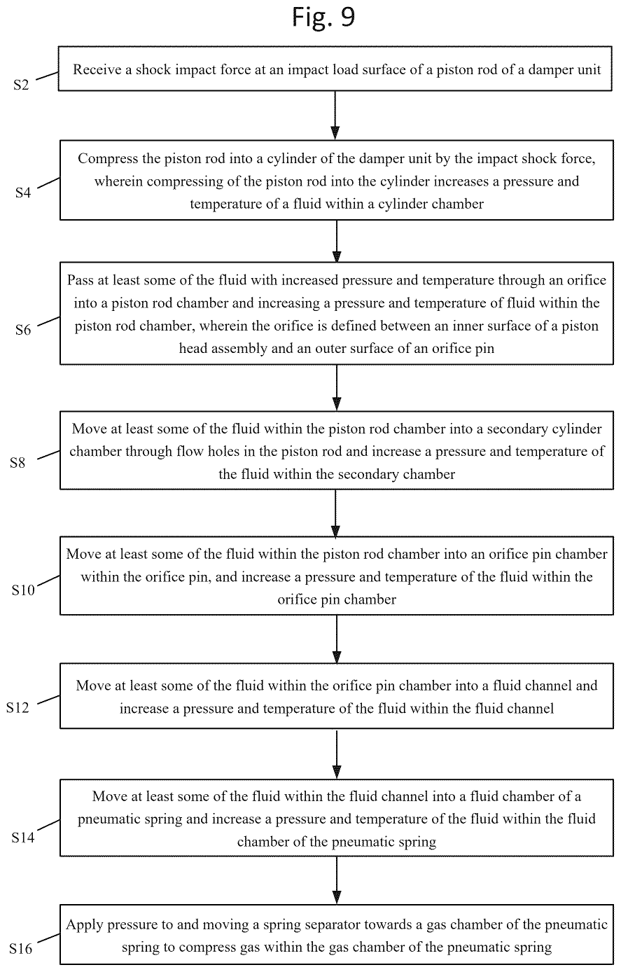

FIG. 9 illustrates a flow diagram for an example method for dampening a shock impact force in accordance with at least some aspects presented herein. This example process may include one or more operations, actions, or functions as illustrated by one or more of blocks S2, S4, S6, S8, S10, S12, S14 and/or S16. Although illustrated as discrete blocks, various blocks may be divided into additional blocks, combined into fewer blocks, or eliminated, depending on the desired implementation.

The method may begin at block S2, “Receive a shock impact force at an impact load surface of a piston rod of a damper unit.” At block S2, a shock impact force may be received by a piston rod of a damper unit. The shock impact force may be applied to an impact load surface of the piston rod.

The method may continue from block S2 to block S4, “Compress the piston rod into a cylinder of the damper unit by the impact shock force, wherein compressing of the piston rod into the cylinder increases a pressure and temperature of a fluid within a cylinder chamber.” At block S4, the piston rod may compress into a cylinder of the damper unit by the impact shock force. The compressing of the piston rod into the cylinder increases a pressure and temperature of a fluid within a cylinder chamber.

The method may continue from block S4 to block S6, “Pass at least some of the fluid with increased pressure and temperature through an orifice into a piston rod chamber and increasing a pressure and temperature of fluid within the piston rod chamber, wherein the orifice is defined between an inner surface of a piston head assembly and an outer surface of an orifice pin.” At block S6, at least some of the fluid with increased pressure and temperature is passed through an orifice into a piston rod chamber and increases a pressure and temperature of fluid within the piston rod chamber. The orifice is defined between an inner surface of a piston head assembly and an outer surface of an orifice pin.

The method may continue from block S6 to block S8, “Move at least some of the fluid within the piston rod chamber into a secondary cylinder chamber through flow holes in the piston rod and increase a pressure and temperature of the fluid within the secondary chamber.” At block S8, at least some of the fluid within the piston rod chamber is moved into a secondary cylinder chamber through flow holes in the piston rod and increases a pressure and temperature of the fluid within the secondary cylinder chamber.

The method may continue from block S8 to block S10, “Move at least some of the fluid within the piston rod chamber into an orifice pin chamber within the orifice pin and increase a pressure and temperature of the fluid within the orifice pin chamber.” At block S10, at least some of the fluid within the piston rod chamber is moved into an orifice pin chamber within the orifice pin and increases a pressure and temperature of the fluid within the orifice pin chamber.

The method may continue from block S10 to block S12, “Move at least some of the fluid within the orifice pin chamber into a fluid channel and increase a pressure and temperature of the fluid within the fluid channel.” At block S12, at least some of the fluid within the orifice pin chamber is moved into a fluid channel and increases a pressure and temperature of the fluid within the fluid channel.

The method may continue from block S12 to block S14, “Move at least some of the fluid within the fluid channel into a fluid chamber of a pneumatic spring and increase a pressure and temperature of the fluid within the fluid chamber of the pneumatic spring.” At block S14, at least some of the fluid within the fluid channel is moved into a fluid chamber of a pneumatic spring and increases a pressure and temperature of the fluid within the fluid chamber of the pneumatic spring.

The method may continue from block S14 to block S16, “Apply pressure to and moving a spring separator towards a gas chamber of the pneumatic spring to compress gas within the gas chamber of the pneumatic spring.” At block S16, pressure is applied to and moves a spring separator towards a gas chamber of the pneumatic spring to compress gas within the gas chamber of the pneumatic spring.

Finally, the processes and techniques described herein are not inherently related to any apparatus and may be implemented by any suitable combination of components. Further, various types of general-purpose devices may be used in accordance with the teachings described herein. It may also prove advantageous to construct specialized apparatus to perform the method steps described herein. This disclosure has been described in relation to the examples, which are intended in all respects to be illustrative rather than restrictive.

The foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A shock load damper comprising:
a damper unit including:
a cylinder including a cylinder chamber with fluid;
a piston rod, wherein the piston rod includes a first end with an impact load surface and a second end with a piston head assembly and the piston rod includes a piston rod chamber with fluid;
an orifice pin including an orifice pin chamber with fluid; and
an orifice defined between an inner surface of the piston head assembly and an outer surface of the orifice pin; and
a pneumatic spring coupled to and in fluid communication with the damper unit.

2. The shock load damper of claim 1, wherein the shock load damper unit is configured with the damper unit above or in parallel to the pneumatic spring.

3. The shock load damper of claim 1, wherein the orifice pin is a metering orifice pin.

4. The shock load damper of claim 3, wherein the orifice pin has a first diameter at a first end and a second diameter at a second end.

5. The shock load damper of claim 4, wherein the orifice decreases in cross-sectional area, or varies as a function of stroke to provide the required damping function when the piston rod is compressed into the cylinder chamber.

6. The shock load damper of claim 1, wherein the dampening unit is configured to provide a non-linear dampening force.

7. The shock load damper of claim 1, wherein the pneumatic spring includes a gas chamber with nitrogen.

8. The shock load damper of claim 1, wherein the pneumatic spring provides preload and a driving force to return the piston rod to a fully extended position when an impact load is removed.

9. The shock load damper of claim 1, wherein the shock load damper is configured to withstand a maximum load of about 35 kN applied in a compression direction on the impact load surface.

10. The shock load damper of claim 1, further comprising a fluid channel between the orifice pin chamber and a spring fluid chamber of the pneumatic spring.

11. The shock load damper of claim 10, further comprising hydraulic fluid within the cylinder chamber, secondary cylinder chamber, piston rod chamber, orifice pin chamber, fluid channel, and the spring fluid chamber.

12. The shock load damper of claim 11, wherein the hydraulic fluid is a thermally stable silicone fluid.

13. The shock load damper of claim 11, wherein the piston rod and orifice pin provide a damping effect to a shock impact with a damping coefficient as a function of displacement and temperature of the hydraulic fluid.

14. A method of dampening a shock impact force, the method comprising:
receiving a shock impact force at an impact load surface of a piston rod of a damper unit;
compressing the piston rod into a cylinder of the damper unit by the impact shock force, wherein compressing of the piston rod into the cylinder increases a pressure and temperature of a fluid within a cylinder chamber;
passing at least some of the fluid with increased pressure and temperature through an orifice into a piston rod chamber and increasing a pressure and temperature of fluid within the piston rod chamber, wherein the orifice is defined between an inner surface of a piston head assembly and an outer surface of an orifice pin;
moving at least some of the fluid within the piston rod chamber into a secondary cylinder chamber through flow holes in the piston rod, and increasing a pressure and temperature of the fluid within the secondary cylinder chamber;
moving at least some of the fluid within the piston rod chamber into an orifice pin chamber within the orifice pin, and increasing a pressure and temperature of the fluid within the orifice pin chamber;
moving at least some of the fluid within the orifice pin chamber into a fluid channel and increasing a pressure and temperature of the fluid within the fluid channel;
moving at least some of the fluid within the fluid channel into a fluid chamber of a pneumatic spring and increasing a pressure and temperature of the fluid within the fluid chamber of the pneumatic spring; and
applying pressure to and moving a spring separator towards a gas chamber of the pneumatic spring to compress gas within the gas chamber of the pneumatic spring.

15. The method of dampening a shock impact force of claim 14, further comprising providing a driving force to return the piston rod to a fully extended position by the pneumatic spring when the impact load force is removed.

16. The method of dampening a shock impact force of claim 14, further comprising, prior to receiving the impact load force, providing a preload to the damper unit by the pneumatic spring.

17. The method of dampening a shock impact force of claim 12, wherein the gas is nitrogen.

18. The method of dampening a shock impact force of claim 12, wherein the dampening unit provides a non-linear dampening force.

19. The method of dampening a shock impact force of claim 12, wherein the fluid is a thermally stable silicone fluid.

20. A shock load damper comprising:
a damper unit including:
a cylinder including a cylinder chamber with fluid;
a piston rod, wherein the piston rod includes a first end with an impact load surface and a second end with a piston head assembly and the piston rod includes a piston rod chamber with fluid;
a metering orifice pin with a first diameter at a first end and a second diameter at a second end, and the metering orifice pin includes an orifice pin chamber with fluid; and
an orifice defined between an inner surface of the piston head assembly and an outer surface of the orifice pin; and
a pneumatic spring including a spring fluid chamber with fluid, a separator, and a gas chamber with nitrogen, and the spring fluid chamber of the pneumatic spring is in fluid communication with the orifice pin chamber through a fluid channel.
